(19) United States
(12) Patent Application Publication
(10) Pub. No.: US 2018/0347526 A1
(43) Pub. Date: Dec. 6, 2018

(54) FUEL PUMP AND FUEL PUMP MODULE

(71) Applicant: DENSO CORPORATION, Kariya-city, Aichi-pref. (JP)

(72) Inventors: Satoshi ITO, Kariya-city (JP); Daiji FURUHASHI, Kariya-city (JP); Yuuji HIDAKA, Kariya-city (JP); Hiromi SAKAI, Kariya-city (JP)

(21) Appl. No.: 15/776,491

(22) PCT Filed: Nov. 25, 2016
(86) PCT No.: PCT/JP2016/084870

§ 371 Date: May 16, 2018

(30) Foreign Application Priority Data
Dec. 17, 2015 (JP) 2015-246454

(51) Int. Cl. F02M 37/22; F02M 37/10

(52) U.S. Cl. CPC F02M 37/22; F02M 2037/228; F02M 37/10

(57) ABSTRACT

A fuel pump is connected to a suction filter which is provided with a filter connecting portion having a cylindrical hole and a projecting portion protruding radially inward from an inner peripheral wall of the cylindrical hole. The fuel pump suctions the fuel filtered by the suction filter. The fuel pump is provided with a suction port having multiple suction openings at a side of the suction filter so as to suction the fuel therethrough, and a pump connecting portion provided at outer side of the multiple suction openings and connected with the filter connecting portion. The pump connecting portion has an outer peripheral wall of which outer shape corresponds with a shape of the inner peripheral wall, and a dent portion denting inward from the outer peripheral wall, which the projecting portion is engaged with.

### CROSS REFERENCE TO RELATED APPLICATION

This application is based on Japanese Patent Application No. 2015-246454 filed on Dec. 17, 2015, the disclosure of which is incorporated herein by reference.

### TECHNICAL FIELD

The present disclosure relates to a fuel pump which is fluidly connected to a suction filter and suctions fuel filtered by the suction filter.

### BACKGROUND ART

Conventionally, it has been known that a fuel pump is fluidly connected to a suction filer and suctions fuel filtered by the suction filter. Patent Literature 1 discloses a fuel pump which is provided with a suction port including a single suction opening and a pump connecting portion arranged at outer side of the single suction opening. A suction filter is provided with a filter connecting portion including a cylindrical hole.

In the fuel pump shown in Patent Literature 1, the filter connecting portion is press-fit to the pump connecting portion. An inner peripheral wall of the cylindrical hole of the filter connecting portion is connected to an outer peripheral wall of the pump connecting portion.

The present inventors made a new configuration of a fuel pump in which multiple suction openings are provided to a suction port. If the pump connecting portion and the filter connecting portion are connected to each other with respect to each suction port, a connecting configuration therebetween will be complicated.

The present inventors have studied a configuration where multiple suction openings are unified to be connected and the pump connecting portion is provided at outer side of the multiple suction openings. Then, the inner peripheral wall of the cylindrical hole of the filter connecting portion is connected to the outer peripheral wall of the pump connecting portion.

However, in such a configuration, it is likely that the circumferential length of the inner peripheral wall and the outer peripheral wall relative to the opening area of the suction openings may become longer than a case of a single suction opening. When both connecting portions are expanded due to fuel property or thermal variation, a clearance is easily generated between the inner peripheral wall and the outer peripheral wall. The connection between the fuel pump and the suction filter becomes loose, so that the suction filter may be disconnected.

### PRIOR ART LITERATURES

### Patent Literature

Patent Literature 1: JP 2014-152726 A

### SUMMARY OF INVENTION

It is an object of the present disclosure to provide a fuel pump and a fuel pump module from which a suction filter is hardly disconnected.

According to a first aspect of the present disclosure, a fuel pump is connected to a suction filter which is provided with a filter connecting portion having a cylindrical hole and a projecting portion protruding radially inward from an inner peripheral wall of the cylindrical hole, and the fuel pump suctions a fuel filtered by the suction filter. The fuel pump has a suction port having a plurality of suction openings at a side of the suction filter so as to suction the fuel therethrough, and a pump connecting portion provided at outer side of the multiple suction openings and connected with the filter connecting portion. The pump connecting portion has an outer peripheral wall of which outer shape corresponds with a shape of the inner peripheral wall, and a dent portion dented inward from the outer peripheral wall, which the projecting portion is engaged with.

The fuel pump is connected to the suction filter which is provided with the filter connecting portion having the projecting portion protruding radially inward from the inner peripheral wall of the cylindrical hole. The pump connecting portion of the fuel pump has the dent portion denting from the outer peripheral wall toward the inner peripheral wall so that the projecting portion is engaged therewith. Thus, even if circumferences of the outer peripheral wall and the inner peripheral wall are increased and a clearance is generated between both walls, the projecting portion is engaged with the dent portion so that the fuel pump and the suction filter are hardly disconnected. As above, it is possible to provide the fuel pump from which the suction filter is less disconnected.

According to a second aspect of the present disclosure, a fuel pump module is provided with a suction filter filtering a fuel and a fuel pump suctioning the fuel filtered by the suction filter. The suction filter is provided with a filter connecting portion having a cylindrical hole and a projecting portion protruding radially inward from an inner peripheral wall of the cylindrical hole. The fuel pump is provided with a suction port having a plurality of suction openings at a side of the suction filter so as to suction the fuel therethrough, and a pump connecting portion provided at outer side of the multiple suction openings and connected with the filter connecting portion. The pump connecting portion has an outer peripheral wall which corresponds with the inner peripheral wall, and a dent portion which dents inward from the outer peripheral wall. The projecting portion is engaged with the convex portion so that the fuel pomp and the suction filter are connected with each other.

The fuel pump is connected to the suction filter which is provided with the filter connecting portion having the projecting portion protruding radially inward from the inner peripheral wall of the cylindrical hole. The pump connecting portion of the fuel pump has the dent portion denting inward from the outer peripheral wall so that the projecting portion is engaged therewith. Thus, even if circumferences of the outer peripheral wall and the inner peripheral wall are increased and a clearance is generated between both walls, the fuel pump and the suction filter are less disconnected. As above, it is possible to provide the fuel pump module from which the suction filter is less disconnected.

### BRIEF DESCRIPTION OF DRAWINGS

The above and other objects, features and advantages of the present disclosure will become more apparent from the following detailed description made with reference to the accompanying drawings.

FIG. 1 is a front view partly in section illustrating a fuel pump according to a first embodiment.

FIG. 2 is a front view partly in section illustrating a fuel pump module according to the first embodiment.

FIG. 3 is a perspective view illustrating a filter connecting portion according to the first embodiment.

FIG. 4 is a cross sectional view taken along a line IV-IV of FIG. 1.

FIG. 5 is a view of a pump cover illustrated in FIG. 1 in a direction of “V”.

FIG. 6 is a view of a pump cover illustrated in FIG. 1 in a direction of “VI”.

FIG. 7 is a cross sectional view taken along a line VII-VII of FIGS. 5 and 6.

FIG. 8 is a chart for explaining a connection between a fuel pump and a suction filter according to the first embodiment.

FIG. 9 is a chart illustrating a filter connecting portion according to a second embodiment.

FIG. 10 is a sectional view illustrating a dent portion according to a first modification.

FIG. 11 is a sectional view illustrating a dent portion according to a second modification.

FIG. 12 is a sectional view illustrating a dent portion according to a third modification.

### DESCRIPTION OF EMBODIMENTS

Referring to drawings, a plurality of embodiments of the present disclosure will be described, hereinafter. In each embodiment, the same parts and the components are indicated with the same reference numeral and the same description will not be reiterated. In a case where only a part of configuration is explained in each embodiment, a configuration of preceding embodiment can be applied as the other configuration. Moreover, the configuration of each embodiment can be combined with each other even if it is not explicitly described.

### First Embodiment

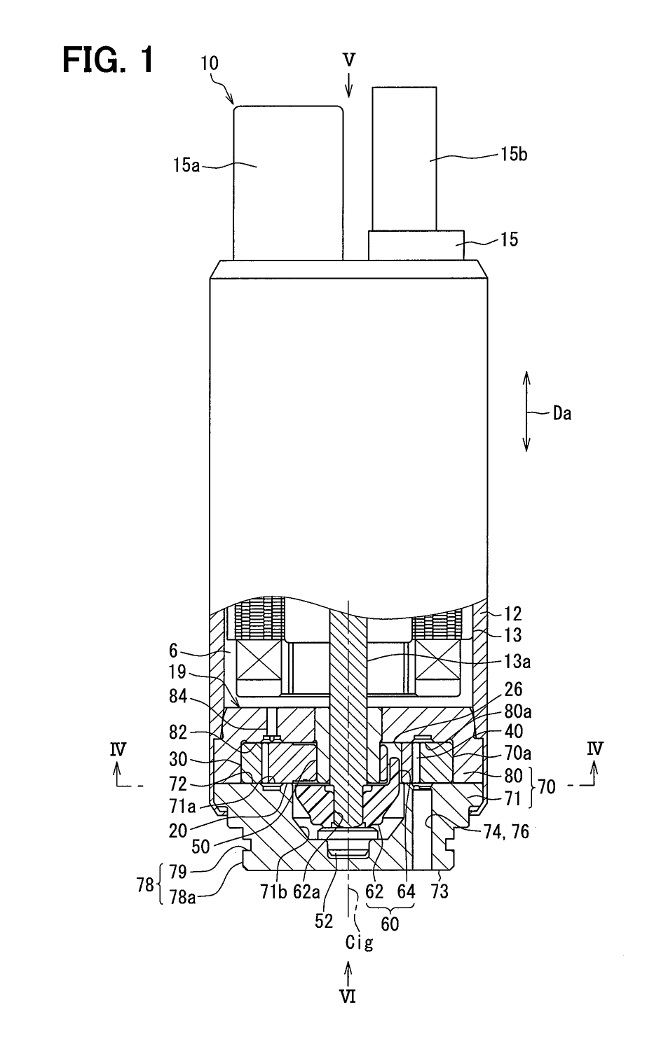

According to a first embodiment of the present disclosure, a fuel pump 10 is a positive displacement trochoid pump, as shown in FIG. 1. The fuel pump 10 is a diesel pump which feeds light oil to an internal combustion engine of a vehicle.

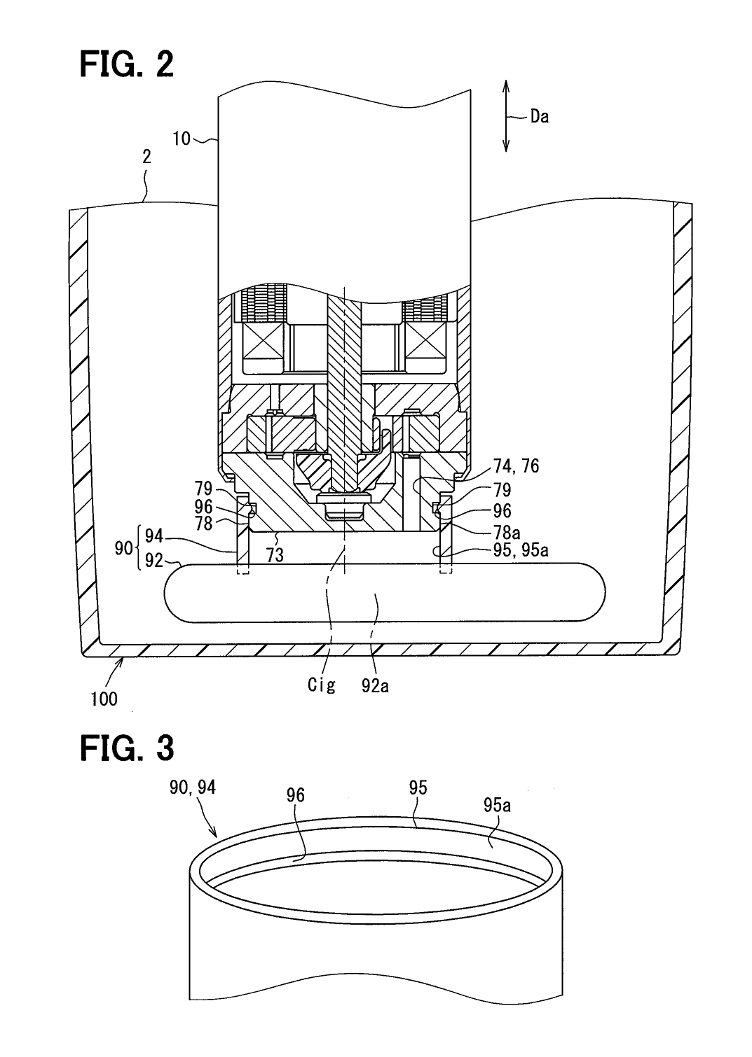

Specifically, as shown in FIG. 2, the fuel pump 10 is disposed in a sub tank 2 of a fuel pump module 100 along with a suction filter 90, which is provided in a fuel tank storing a fuel. The fuel pump module 100 supplies the fuel in the fuel tank to the internal combustion engine.

As shown in FIGS. 2 and 3, the suction filter 90 is arranged above a bottom portion of the sub tank 2, and is provided with a filter element 92 and a filter connecting portion 94. The filter element 92 is a bag defining an inner space 92a therein. The filter element 92 filters the fuel to remove foreign matters, such as sand, duct, and rust, from the fuel. Since light oil has higher viscosity than gasoline and becomes jelly state in a low-temperature condition, the mesh of the filter element 92 is set rougher than a case of gasoline (for example, 100-200 μm).

The filter connecting portion 94 is formed cylindrical as a whole. The filter connecting portion 94 is made from synthetic resins, such as polyphenylene sulfide (PPS) resin or polyacetal (POM) resin. The filter connecting portion 94 has a cylindrical hole 95 and a projecting portion 96. A cylindrical hole 95 has a cylindrical inner surface and one end connected to an inner space 92a of the filter element 92. The other end of the cylindrical hole 95 is opened.

The projecting portion 96 inwardly protrudes from an inner peripheral wall 95a of the cylindrical hole 95. Especially, according to the first embodiment, the projecting portion 96 is formed annularly. Moreover, the projecting portion 96 protrudes in such a manner that its longitudinal cross section is arc-shaped.

The fuel pump 10, which is connected to the suction filter 90, is provided with an electric motor 13 accommodated by an annular pump body 12, a pump 19, and a side cover 15 which extend in an axial direction Da to cover the electric motor 13 and the pump 19.

The electric motor 13 receives electric power from an external circuit through an electric connector 15a provided to the side cover 15, whereby a shaft 13a is rotationally driven. An outer gear 30 and an inner gear 20 of the pump 19 are rotated by a driving force of the shaft 13a. Thereby, the fuel is introduced into a gear room 70a which accommodates both gears 20, 30. The compressed fuel is discharged from an outlet port 15b provided to the side cover 15 through a fuel passage 16 defined outside of the gear room 70a.

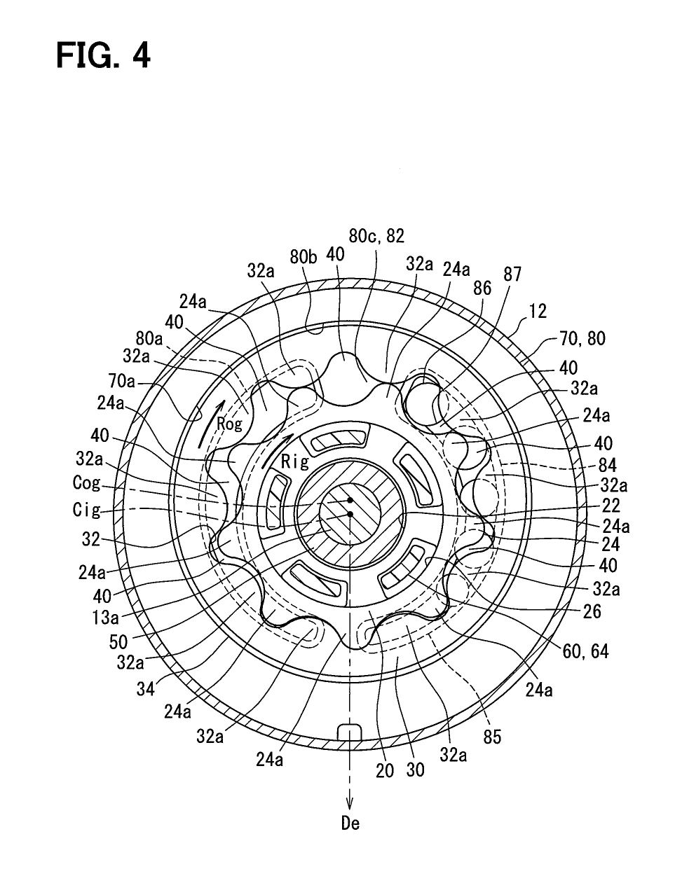

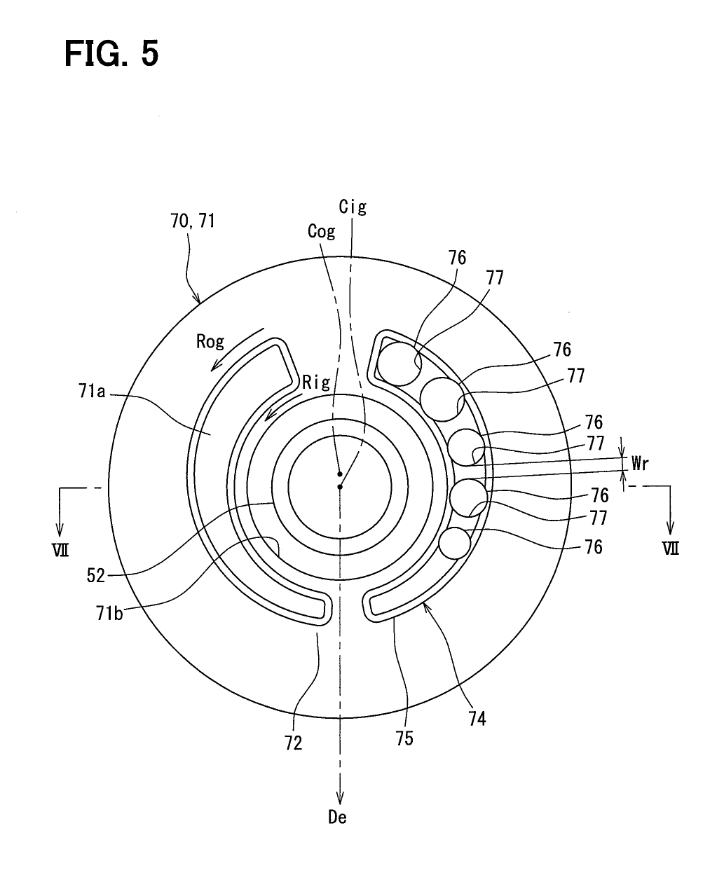

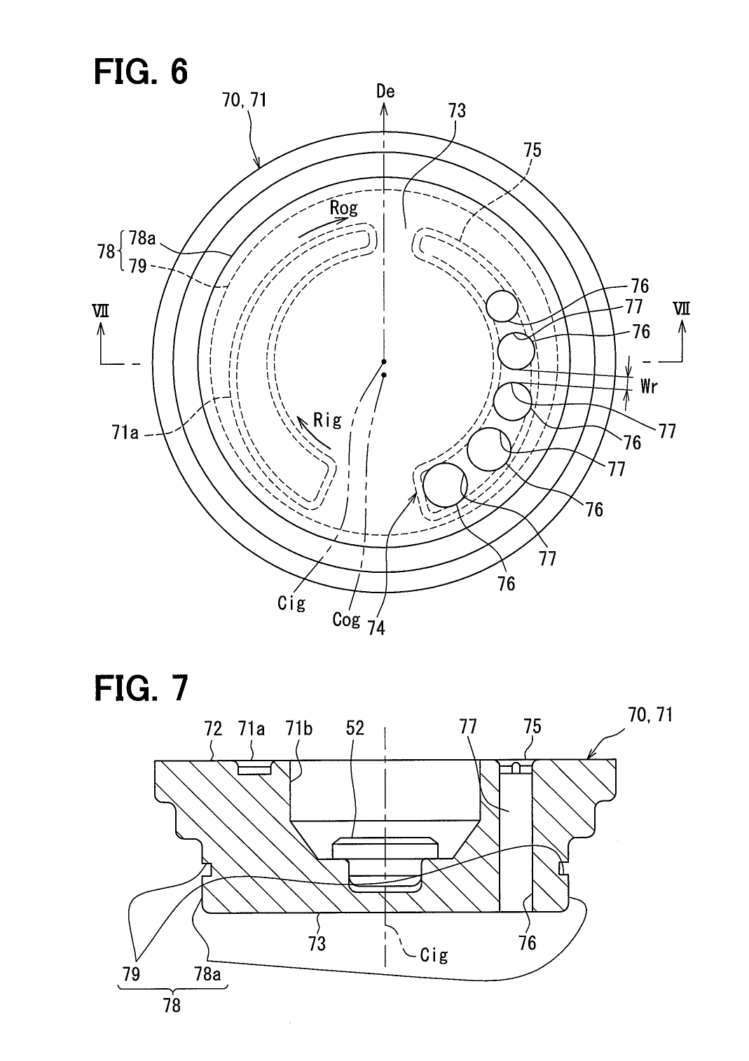

Referring to FIGS. 4 to 8, a configuration and an operation of the fuel pump 10, especially of the pump 19 will be described. The pump 19 is provided with a joint member 60, the inner gear 20, the outer gear 30, and a pump housing 70.

The joint member 60 shown in FIGS. 1 and 4 is made from synthetic resins, such as PPS resin, and connects the shaft 13a to the inner gear 20. The joint member 60 has a main body 62 and an insert portion 64. The shaft 13a is inserted into an engage hole 62a of the main body 62. A plurality of insert portions 64 are formed at regular intervals in a circumferential direction. Each of the insert portions 64 elastically extends to the gear room 70a in the axis direction Da around the engage hole 62a.

The inner gear 20 shown in FIGS. 1 and 4 is made from metallic material having stiffness, such as ferrous sintered body, for example. The inner gear 20 is a trochoid gear having trochoid-curved gear teeth. An inner-center line Cig passing through a center of the inner gear 20 is aligned with the shaft 13a, so that the inner gear 20 is eccentrically arranged in the gear room 70a.

The inner gear 20 has an insert hole 26 which faces to the main body 62 of the joint member 60 in the axial direction Da. A plurality of insert holes 26 are formed at regular intervals in a circumferential direction so as to correspond to each of the insert portions 64. Each of the insert holes 26 penetrates the inner gear 20 in the axial direction Da.

Each of the insert portions 64 is inserted into each of the insert holes 26. When the shaft 13a is rotationally driven, each of the insert portions 64 abuts on an inner surface of each insert hole 26 and a driving force of the shaft 13a is transmitted to the inner gear 20 through the joint member 60. That is, the inner gear 20 can rotate in a rotational direction Rig around the inner-center line Cig. It should be noted that only a part of the insert holes 26 and the insert portions 64 are indicated with numeral references in FIG. 4.

Moreover, as shown in FIG. 4, the inner gear 20 has a plurality of external teeth 24a on its outer periphery 24, which are formed at regular intervals in the rotational direction Rig.

The outer gear 30 shown in FIGS. 1 and 4 is made from metallic material having stiffness, such as ferrous sintered body, for example. The inner gear 20 is a trochoid gear having trochoid-curved gear teeth. The outer gear 30 is eccentric to the inner-center line Cig of the inner gear 200 so as to be concentric to the gear room 70a. Thus, the inner gear 20 is eccentric to the outer gear 30 in an eccentric direction De which is a radial direction of the outer gear 30.

The outer gear 30 can rotate in a rotational direction Rog around an outer-center line Cog which is eccentric to the inner-center line Cig, along with the inner gear 20. The outer gear 30 has a plurality of internal teeth 32a on its inner periphery 32, which are formed at regular intervals in the rotational direction Rog. The number of the internal teeth 32a of the outer gear 30 is larger than that of the external teeth 24a of the inner gear 20 by one. According to the present embodiment, the number of the internal teeth 32a is ten, and the number of the external teeth 24a is nine.

The inner gear 20 is eccentric to the outer gear 30 in the eccentric direction De to be engaged with the outer gear 30. Thereby, both gears 20, 30 are engaged with each other in the eccentric direction with less clearance, and a plurality of pump chambers 40 are defined between both gears 20, 30 on anti-eccentric side. When the outer gear 30 and the inner gear 20 rotate with each other, the volume of the pump chamber 40 are increased and decreased. As above, the outer gear 30 and the inner gear 20 configure a rotor portion which rotates in the gear room 70a (rotor room).

As shown in FIG. 1, the pump housing 70 defines the gear room 70a which rotatably accommodates both gears 20, 30 by confronting a pump cover 71 and the pump casing 80 with each other. Thereby, the pump housing 70 holds the both gears 20, 30 from both end sides in the axial direction Da to define sliding surfaces 72, 82 on which the both gears 20, 30 slide.

The pump cover 71 shown in FIGS. 1, 5 to 7 is one of component parts of the pump housing 70. The pump cover 71 is a disk having abrasion resistance, which is configured by a metallic base member made from steel material with surface treatment, such as plating. The pump cover 71 has a flat projecting surface 73 facing to the suction filter 90 in the axial direction Da.

The pump cover 71 has a joint accommodation chamber 71b which accommodates the main body 62 of the joint member 60 at a position facing to the inner gear 20 on the inner-center line Cig. The joint accommodation chamber 71b is dented from the sliding surface 72 along the axial direction Da. A thrust bearing 52 fixed at a bottom portion of the joint accommodation chamber 71b on the inner-center line Cig in order to support the shaft 13a in the axial direction Da.

The pump cover 71 has a suction port 74 through which the fuel is suctioned from an outside of the gear room 70a into an inside of the gear room 70a at a position outer of the joint accommodation chamber 71b. The suction port 74 has a suction extension groove 75 and a plurality of suction openings 76. The suction extension groove 75 is formed on the sliding surface 72 and has an arc shape extending in a circumferential direction of the pump cover 71. For example, five suction openings are formed in an extending direction of the suction extension groove 75. Each of the suction openings 76 penetrates the pump cover 71 in the axial direction Da. One end of each suction opening 76 is opened on a bottom surface of the suction extension groove 75 and the other end is opened at the flat projecting surface 73.

An opening area of the each suction opening 76 is defined according to the volume of the corresponding pump chamber 40. The opening area of the suction opening 76 which is located at anti-eccentric position is defined largest. A stiffening rib 77 for reinforcing the pump cover 71 is formed between adjacent suction openings 76. A width Wr of the stiffening rib 77 is substantially equal to each other between adjacent suction openings 76.

The pump cover 71 has a pump connecting portion 78 facing to the suction filter 90. The pump connecting portion 78 has an outer peripheral wall 78a and a dent portion 79 which are located outside of the suction openings 76. The outer peripheral wall 78a is cylindrically shaped so as to be fit to an inner peripheral wall 95a of the filter connecting portion 94. The dent portion 79 is dented inwardly from the outer peripheral wall 78a. Especially, according to the first embodiment, the dent portion 79 is formed annularly. Moreover, a longitudinal section of the dent portion 79 is rectangle of which angle is a right angle. The outer peripheral wall 78a and the dent portion 79 are arranged concentrically with the inner-center line Cig of the pump cover 71.

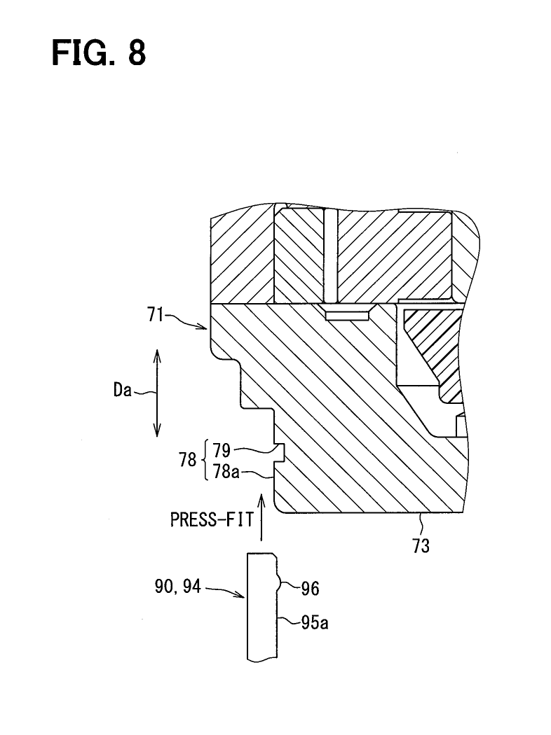

When the fuel pump module 100 is assembled, the pump connecting portion 78 is connected to the filter connecting portion 94. Specifically, as shown in FIG. 8, the filter connecting portion 94 is press-fitted to the pump connecting portion 78 along the axial direction Da. The inner peripheral wall 95a of the cylindrical hole 95 is in contact with the outer peripheral wall 78a circumferentially. The projecting portion 96 is engaged with the dent portion 79 circumferentially. By connecting both connecting portions 78, 94 to each other, each of the suction openings 76 is connected with the inner space 92a of the filter element 92 through the cylindrical hole 95.

According to a comparison between materials of the pump cover 71 and the filter connecting portion 94, an expansion coefficient of the pump connecting portion 78 is smaller than that of the filter connecting portion 94. More specifically, a linear expansion coefficient which varies according to a variation in temperature is employed as one of the expansion coefficient. Moreover, a degree of swelling can be employed as another expansion coefficient.

The pump casing 80 shown in FIGS. 1 and 4 is one of component parts of the pump housing 70. The pump casing 80 is a cup having abrasion resistance, which is configured by a metallic base member made from steel material with surface treatment, such as plating. An opening of the pump casing 80 is closed by the pump cover 71. An inner peripheral surface 80b of the pump casing 80 is eccentric to the inner-center line Cig, and is concentric with the outer-center line Cog.

A radial bearing 50 is fixed at a bottom portion 80c on the inner-center line Cig in order to support the shaft 13a which penetrates the bottom portion 80c.

The pump casing 80 has a discharge port 84 through which the fuel is discharged from the inside of the gear room 70a into the outside of the gear room 70a at a position outer of the radial bearing 50. The discharge port 84 has a discharge extension groove 85 and a plurality of discharge openings 86. The discharge extension groove 85 is formed on the sliding surface 82 and has an arc shape extending in a circumferential direction of the pump casing 80. A plurality of discharge openings 86 are formed in an extending direction of the discharge extension groove 85. Each of the discharge openings 86 penetrates the pump casing 80 in the axial direction Da. One end of each discharge opening 86 is opened on a bottom surface of the discharge extension groove 85 and the other end is opened at the fuel passage 16. It should be noted that a part of the discharge openings 86 are indicated with numeral references in FIG. 4.

A suction confront groove 80a is formed on the bottom portion 80c of the pump casing 80 at a position confronting the suction extension groove 75 of the suction port 74 through the gear room 70a. The suction confront groove 80a has an arc shape which corresponds to the suction extension groove 75 in the axial direction Da. The suction confront groove 80a is dented from the sliding surface 82. In the pump casing 80, the discharge extension groove 85 and the suction confront groove 80a are axial symmetric. The sliding surface 82 is positioned between the discharge extension groove 85 and the suction confront groove 80a.

A discharge confront groove 71a is formed on the pump cover 71 at a position confronting the discharge extension groove 85 of the discharge port 84 through the gear room 70a. The discharge confront groove 71a has an arc shape which corresponds to the discharge extension groove 85 in the axial direction Da. The discharge confront groove 71a is dented from the sliding surface 72. In the pump cover 71, the suction extension groove 75 and the discharge confront groove 71a are axial symmetric. The sliding surface 72 is positioned between the suction extension groove 75 and the discharge confront groove 71a.

In the gear room 70a defined by the pump housing 70, an axial width of the inner gear 20 is slightly smaller than a distance between the sliding surfaces 72 and 82. An inner peripheral surface 22 of the inner gear 20 is radially supported by the radial bearing 50. Both axial end surfaces of the inner gear 20 in the axial direction Da are supported by the sliding surfaces 72, 82.

Moreover, an outer diameter of the outer gear 30 is slightly smaller than an inner diameter of the pump casing 80. An axial width of the outer gear 30 is slightly smaller than the distance between the sliding surfaces 72 and 82. An outer peripheral surface 34 of the outer gear 30 is radially supported by an inner peripheral surface 80b of the pump casing 80. Both axial end surfaces of the outer gear 30 in the axial direction Da are supported by the sliding surfaces 72, 82.

Along with rotation of both gears 20, 30, the volume of the pump chamber 40 which communicates with the suction port 74 and the suction confront groove 80a is increased. As the result, the fuel is suctioned into the pump chamber 40 in the gear room 70a through each of the suction openings 76 of the suction port 74. Since each of the suction openings 76 communicates with the suction extension groove 75 dented from the sliding surface 72, the fuel suctioning is continued while the pump chamber 40 faces to the suction extension groove 75.

Along with rotation of both gears 20, 30, the volume of the pump chamber 40 which communicates with the discharge port 84 and the discharge confront groove 71a is decreased. As a result, the fuel in the pump chamber 40 is discharged outside the gear room 70a through each of the discharge openings 86 of the discharge port 84. Since each of the discharge openings 86 communicates with the discharge extension groove 85 dented from the sliding surface 82, the fuel discharging is continued while the pump chamber 40 faces to the discharge extension groove 85.

The fuel pump 10 suctions the fuel filtrated by the suction filter 90 through the suction port 74. The fuel is suctioned into the pump chamber 40 in the gear room 70a through the suction port 74, and then discharged into a fuel passage 16 through the discharge port 84. The fuel in the fuel passage 16 is discharged outside the fuel pump 10 through the outlet port 15b.

### (Functions and Effects)

Functions and effects of the first embodiment will be described, hereinafter.

According to the first embodiment, the fuel pump 10 is connected to the suction filter 90 which is provided with the filter connecting portion 94 having the projecting portion 96 protruding radially inward from the inner peripheral wall 95a of the cylindrical hole 95. The pump connecting portion 78 of the fuel pump 10 has the dent portion 79 denting from the outer peripheral wall 78a so that the projecting portion 96 is engaged therewith. Thus, even if circumferences of the outer peripheral wall 78a and the inner peripheral wall 95a are increased and a clearance is likely generated between both walls 78a and 95a, the projecting portion 96 is engaged with the dent portion 79, so that it is restricted that the fuel pump 10 and the suction filter are disconnected from each other. As above, it is possible to provide the fuel pump 10 from which the suction filter 90 is less disconnected.

Moreover, according to the first embodiment, the projecting portion 96 is circumferentially engaged with the dent portion 79. Thus, a contacting area between the projecting portion 96 and the dent portion 79 is enlarged. Even if a clearance is generated between both walls 78a and 95a, a position aberration is less generated between both connecting portions 78 and 94 in the axial direction Da. A disconnection between the fuel pump 10 and the suction filter 90 is further restricted. It can be restricted that the suction filter 90 is disconnected from the fuel pump 10.

According to the first embodiment, the dent portion 79 has rectangular edges. When the projecting portion 96 is engaged with the dent portion 79, the projecting portion 96 is engaged with rectangular edges, which restricts a disconnection between the fuel pump 10 and the suction filter 90. It can be restricted that the suction filter 90 is disconnected from the fuel pump 10.

Moreover, according to the first embodiment, the pump cover 71 has the pump connecting portion 78 and the multiple suction openings 76. The outer peripheral wall 78a and the dent portion 79 of the pump connecting portion 78 are arranged concentrically with the center line of the pump cover 71. According to the above concentric configuration, the dent portion 79 can be easily formed by cutting the pump cover 71 while rotating pump cover 71 around its center axis. Thus, it is possible to provide the fuel pump 10 from which the suction filter 90 is less disconnected.

According to the first embodiment, in the fuel pump module 100, the fuel pump 10 is connected to the suction filter 90 which is provided with the filter connecting portion 94 having the projecting portion 96 protruding radially inward from the inner peripheral wall 95a of the cylindrical hole 95. The pump connecting portion 78 of the fuel pump 10 has the dent portion 79 denting from the outer peripheral wall 78a so that the projecting portion 96 is engaged therewith. Thus, even if circumferences of the outer peripheral wall 78a and the inner peripheral wall 95a are increased and a clearance is likely generated between both walls 78a and 95a, the projecting portion 96 is engaged with the dent portion 79, so that it is restricted that the fuel pump 10 and the suction filter are disconnected from each other. As above, it is possible to provide a fuel pump module in which the suction filter 90 is less disconnected from the fuel pump 10.

### Second Embodiment

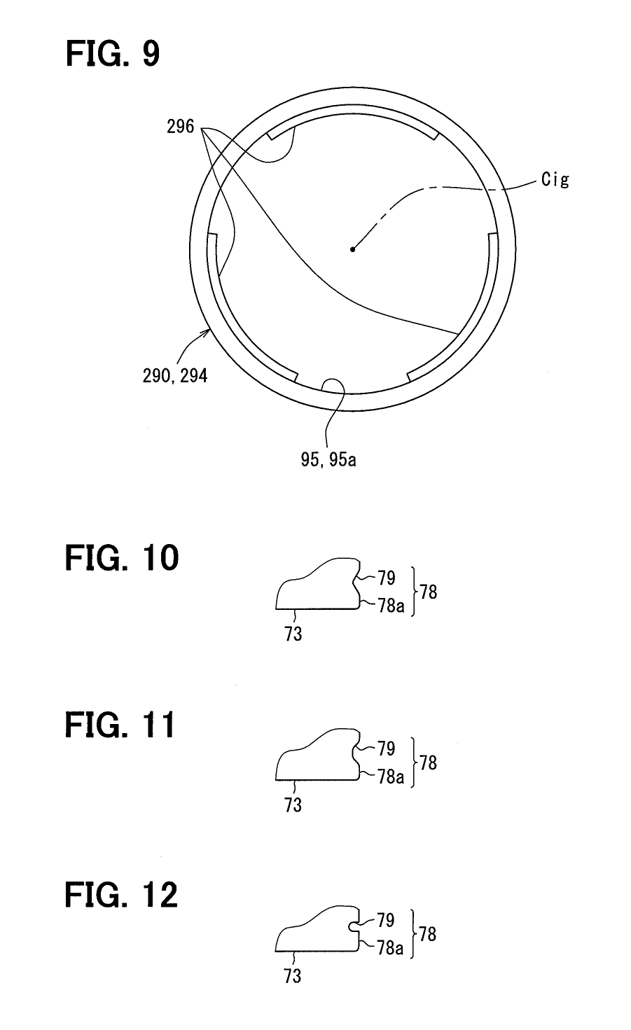

As shown in FIG. 9, a second embodiment of the present disclosure is a modification of the first embodiment. Hereinafter, a second embodiment will be described while focusing on points different from the first embodiment.

In a suction filter 290 of the second embodiment, projecting portions 296 are intermittently formed in a circumferential direction. More specifically, a plurality of projecting portions 296 are formed at regular intervals. According to the present embodiment, the projecting portions 296 are formed at three positions. A total circumferential length of the projecting portions 296 is longer than half of whole circumferential length of the inner peripheral wall 95a. Similar to the first embodiment, each of the projecting portions 296 has an arc shaped longitudinal section.

The dent portion 79 is formed at entire perimeter, similar to the first embodiment. Moreover, a longitudinal section of the dent portion 79 is rectangle of which angle is a right angle.

According to the second embodiment, a filter connecting portion 294 is press-fit to the pump connecting portion 78 in the axial direction Da, the inner peripheral wall 95a and the outer peripheral wall 78a are in contact with each other circumferentially, and the projecting portions 296 is engaged with the dent portion 79.

Since multiple projecting portions 296 are engaged with the dent portion 79, even if a clearance is generated between both walls 78a and 95a, it can be restricted that the fuel pump 10 and the suction filter 290 are disconnected from each other. It can be restricted that the suction filter 290 is disconnected from the fuel pump 10.

### Another Embodiment

While the present disclosure has been described with reference to embodiments thereof, it is to be understood that the disclosure is not limited to the embodiments and constructions. The present disclosure is intended to cover various modification and equivalent arrangements within the spirit and scope of the present disclosure.

Specifically, according to a first modification, as shown in FIG. 10, the dent portion 79 may have V-shaped longitudinal section.

According to a second modification, as shown in FIG. 11, the dent portion 79 may have arc shaped longitudinal section.

According to a third modification, as shown in FIG. 12, the dent portion 79 may have U-shaped longitudinal section.

According to a fourth modification, a longitudinal section of the dent portion 79 may have an obtuse angle or an acute angle.

According to a fifth modification of the second embodiment, the dent portion 79 may not be always formed at entire circumference. For example, the dent portion 79 may be formed intermittently at positions corresponding to the projecting portions 296.

According to a sixth modification, the outer peripheral wall 78a and the dent portion 79 may be arranged eccentric to the center axis (for example, the inner-center line Cig) of the pump cover 71.

According to a seventh modification, the fuel may be gasoline. That is, the fuel pump module 100 may be provided in a fuel tank which stores fuel other than light oil.

1. A fuel pump connected to a suction filter which is provided with a filter connecting portion having a single cylindrical hole and a projecting portion protruding radially inward from an inner peripheral wall of the cylindrical hole, the fuel pump suctioning a fuel filtered by a filter element of the suction filter, the fuel pump comprising:
a suction port having multiple suction openings at a side facing to the suction filter so as to suction the fuel therethrough; and
a pump connecting portion provided at outer side of the multiple suction openings and connected with the filter connecting portion; wherein
the multiple suction openings communicate with an inner space of the filter element through the single cylindrical hole,
the pump connecting portion has an outer peripheral wall of which outer shape corresponds with a shape of the inner peripheral wall, and a dent portion denting inward from the outer peripheral wall, which the projecting portion is engaged with.

2. The fuel pump according to claim 1, wherein
the dent portion is annularly formed on entire circumference of the outer peripheral wall, and
the projection portion is annularly formed to be engaged with the dent portion.

3. The fuel pump according to claim 1, wherein
the projection portion which is intermittently formed in a circumferential direction is engaged with the dent portion.

4. The fuel pump according to claim 1, wherein
the dent portion has an edge which is rectangle.

5. The fuel pump according to claim 1, wherein
the pump connecting portion and the multiple suction openings are formed on a same pump component part, and
the outer peripheral wall and the dent portion of the pump connecting portion are concentrically formed with respect to a center axis of the pump component part.

6. A fuel pump module comprising:
a suction filter filtering a fuel by means of a filter element: and
a fuel pump suctioning the fuel filtered by the suction filter, wherein
the suction filter provided with a filter connecting portion having a single cylindrical hole and a projecting portion protruding radially inward from an inner peripheral wall of the cylindrical hole,
the fuel pump provided with a suction port having a plurality of suction openings at a side facing to the suction filter so as to suction the fuel therethrough; and a pump connecting portion provided at outer side of the multiple suction openings and connected with the filter connecting portion;
the multiple suction openings communicate with an inner space of the filter element through the single cylindrical hole,
the pump connecting portion has an outer peripheral wall of which outer shape corresponds with a shape of the inner peripheral wall, and a dent portion denting inward from the outer peripheral wall, and
the fuel pump and the suction filter are connected with each other in a state where the projecting portion is engaged with the dent portion.
